(19) United States
(12) Patent Application Publication
(10) Pub. No.: US 2023/0252339 A1
(43) Pub. Date: Aug. 10, 2023

(54) SYSTEM AND METHOD FOR ELECTRONIC DATA FLOW OPTIMIZATION VIA INTELLIGENT MACHINE LEARNING

(71) Applicant: BANK OF AMERICA CORPORATION, Charlotte, NC (US)

(72) Inventors: Stephanie Hope Loflin, Archdale, NC (US); Deepali Dadhich, Westlake Village, CA (US); Gregory Irwin Eads, Saint Johns, FL (US)

(73) Assignee: BANK OF AMERICA CORPORATION, Charlotte, NC (US)

(21) Appl. No.: 17/665,229

(22) Filed: Feb. 4, 2022

(51) Int. Cl. H04L 45/00; H04L 67/125

(52) U.S. Cl. CPC H04L 45/08; H04L 67/125; H04L 45/14

(57) ABSTRACT

Embodiments of the invention are directed to a system, method, or computer program product for an approach to optimizing electronic data flow using intelligent machine learning. An optimization request is received by a data flow optimizer tool, wherein data flow and data flow step variables and statistics are provided to an automation platform. The automation platform simulates optimized data flow patterns and works in conjunction with a machine learning platform to improve efficiency of the automation platform by learning from data and recognizing patterns and features of data flow and data flow steps.

### BACKGROUND

Currently, data flows are a result of executing normal activities of the entity. Oftentimes, steps of the data flow are performed manually, and factors such as throughput and variation may lead to inefficient data flow. In occurrences where steps of the data flow are automated and performed by machine, the automation is often performed ad hoc and without respect to the other steps of the data flow. As such, there exists a need for a system and method for electronic data flow optimization via intelligent machine learning.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatuses (e.g., a system, computer program product and/or other devices) and methods for optimizing electronic data flow via intelligent machine learning.

Currently, entities have numerous processes, and many processes comprise a multitude of data flows. In some data flows, humans are responsible for performing data flow steps or carrying out tasks as identified within a data flow for a process. This leads to longer processing times, higher and unnecessary likelihoods of error when performing data flow steps, incorrect routing of each data flow step, or the like. Many of these data flow steps are capable of being automated, but without proper machine learning or intelligence in the automation system, the individual data flow steps are once again prone to errors or unnecessary processing time/lag. The system described herein is capable of receiving information in an automation platform about a current data flow from a user, such as the data flow steps, the current cycle times, touch times, rework times, or wait times for each of the data flow steps. The system also performs value assessment of each of the data flow steps, optionality, and level of automation capacity for each data flow step, and opportunities for simultaneous execution for each data flow step. The automation platform outputs numerous configurations or options of possible automated data flows to replace the incumbent data flow, and in doing so provides key output metrics wherein the key output metrics may include, but are not limited to: cycle time, effective touch time, and/or cost savings. In this way, the automation platform provides guidance to a user for selecting the appropriate automated data flow, and also provides numerous options so that a user may be able to select the automated data flow which best represents the needs of the entity. After one or more optimized data flows as outputs of the automation platform are provided to a user and a user selects the appropriate optimized data flow, the selection, as well as the automation used to determine the optimized data flow within the automation platform, are provided to a machine learning platform. In this machine learning platform, the machine learning platform learns and stores data and patterns in order to recognize selection patterns, automation platform processes used to determine the optimized data flow, or the like, in order to increase efficiency of the overall system over time. The system is capable of analyzing data flows which have previously been analyzed, such as to improve the data flows in the future once the machine learning platform has matured.

Embodiments of the invention are directed to a system, method, or computer program product for optimizing electronic data flow using intelligent machine learning, the invention comprising receiving an optimization request, wherein the optimization request is input to a data flow optimizer tool, inputting a data flow into an automation platform of the data flow optimizer tool, wherein the data flow comprises one or more data flow steps, and wherein inputting the data flow into the automation platform comprises separating each data flow step from the other data flow steps, indicating for the one or more data flow steps the current cycle time, touch time, rework time, or wait time, performing a value assessment of the one or more data flow steps, indicating for the one or more data flow steps the optionality and level of automation, and determine the opportunity for simultaneous execution, and indicating one or more key output metrics to the automation platform.

In some embodiments, the system, method, or computer program product further comprises initiating the automation platform, simulating a plurality of data flows via the automation platform, outputting one or more options of optimized data flows, wherein each of the one or more options of optimized data flows comprises displaying the one or more data flow steps to be at least one of: automated, eliminated, or reorganized, displaying an estimate of the one or more key output metrics, providing output data from the options of optimized data flow to a machine learning platform, wherein the machine learning platform learns and stores data and patterns to increase efficiency of the data flow optimizer tool over time, and selecting an option of optimized data flow for implementation, wherein the selection is determined from estimates of the one or more key output metrics.

In some embodiments, or in combination with any of the previous embodiments, performing value assessment of the one or more data flow steps comprises determining value-add data flow steps, wherein the value-add data flow steps are the data flow steps comprising transforming a request into a fulfilled request and wherein the data flow step requires no rework, determining non-value-add data flow steps, wherein the non-value-add data flow steps are the data flow steps comprising the request not directly transforming into a fulfilled request, and determining required non-value-add data flow steps, wherein the required non-value-add data flow steps comprise the non-value-add data flow steps comprising enterprise or regulatory purpose.

In some embodiments, or in combination with any of the previous embodiments, the optimization request is provided to the data flow optimizer tool by a user on a graphical user interface of a device of the user.

In some embodiments, or in combination with any of the previous embodiments, the optimization request is autonomously provided to the data flow optimizer tool by the processing device, the processing device providing the optimization request for a previously optimized data flow.

In some embodiments, or in combination with any of the previous embodiments, the machine learning platform is further configured to output a tutorial for optimized data flow design, the tutorial indicating to a user instructions for data flow layout.

In some embodiments, or in combination with any of the previous embodiments, the one or more key output metrics provided to the automation platform are prioritized, the prioritized key output metrics indicating to the automation platform the weight to be given to the one or more key output metrics during simulation of a plurality of data flows.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates a network environment in which the processes described herein are implemented, in accordance with some embodiments of the present invention;

FIG. 2 illustrates a block diagram of a method for providing inputs to a system for optimizing electronic data flow using intelligent machine learning, in accordance with some embodiments of the present invention;

FIG. 3 illustrates a block diagram of generating outputs from a system and method for optimizing electronic data flow using intelligent machine learning, in accordance with some embodiments of the present invention;

FIG. 4 illustrates a block diagram of a system and method for performing a value assessment of a data flow step, in accordance with some embodiments of the invention; and

FIG. 5 illustrates a block diagram of a data flow optimizer tool, in accordance with some embodiments of the invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

Embodiments of the invention are directed to a system, method, or computer program product for an approach to optimizing electronic data flow using intelligent machine learning. An optimization request is received by a data flow optimizer tool, wherein data flow and data flow step variables and statistics are provided to an automation platform. The automation platform simulates optimized data flow patterns and works in conjunction with a machine learning platform to improve efficiency of the automation platform by learning from data and recognizing patterns and features of data flow and data flow steps.

In accordance with embodiments of the invention, the term “entity” may be used to include any organization or collection of users that may interact with a network. An entity may refer to a business, company, or other organization that either maintains or operates the system or requests use and accesses the system. “Entity” may be used to include any organization that processes financial transactions including, but not limited to, banks, credit unions, savings and loan associations, investment companies, stock brokerages, resource management firms, insurance companies or the like.

A “user” as used herein may refer to any entity or individual associated with the system. In some embodiments, a user may be a computing device user, a phone user, a mobile device application user, a financial institution customer (e.g., an account holder or a person who has an account (e.g., banking account, credit account, or the like)), a system operator, database manager, a support technician, and/or employee of an entity. In some embodiments, identities of an individual may include online handles, usernames, identification numbers (e.g., Internet protocol (IP) addresses), aliases, family names, maiden names, nicknames, or the like. In some embodiments, the user may be an individual or an organization (i.e., a charity, business, company, governing body, or the like).

Furthermore, as used herein the term “user device” may refer to any device that employs a processor and memory and can perform computing functions, such as a personal computer or a mobile device, wherein a mobile device is any mobile communication device, such as a cellular telecommunications device (i.e., a cell phone or mobile phone), personal digital assistant (PDA), a mobile Internet accessing device, or other mobile device. Other types of mobile devices may include portable digital assistants (PDAs), pagers, wearable devices, mobile televisions, laptop computers, cameras, video recorders, audio/video player, radio, global positioning system (GPS) devices, or any combination of the aforementioned. In some embodiments, a device may refer to an entity's computer system, platform, servers, databases, networked devices, or the like. The device may be used by the user to access the system directly or through an application, online portal, internet browser, virtual private network, or other connection channel. The device may be a computer device within a network of connected computer devices that share one or more network storage locations.

As used herein, the term “automation platform” may refer to any software or software-implemented system which is configured to perform robotic process automation (“RPA”). The automation platform may collect data from a user and orchestrate various applications using the user interface (“UI”) of a user device. The automation platform is capable of automating repetitive tasks, and may allow for automation with assistance of visual diagrams such as data flowcharts or the like. The automation platform may be configured with a built-in recorder, such that users may record their activities on various applications for automation during playback. The automation platform may consist of multiple layers, or layers of architecture, such as a client layer, a server layer, and a persistency layer. The client layer of the automation platform is user-facing and allows access by users for the user to design and implement various tasks which are to be automated. The server layer may display the details of an underlying server, and may store an entire automation project once the automation project is fully implemented. The server layer may comprise an orchestrator that monitors activities, generates output reports, and schedules automation. The automation platform may also comprise a persistency layer, such that the persistency layer stores configuration details of the automation such as assigned tasks, data logs, and user data.

As used herein, the term “machine learning” may refer to an algorithm as part of an artificial intelligence built using data of a system to make decisions or predictions without the need of being discretely programmed to make decisions or predictions. Machine learning may implement numerous approaches such as supervised learning, unsupervised learning, reinforcement learning, or the like, in order to convert mined data into the machine learning algorithm. Various models for machine learning may be created and implemented, such as artificial neural networks, decision trees, support-vector machines, regression analysis, training models, Bayesian networks, federated learning, or the like.

As used herein, the term “machine learning platform” may refer to any software or software-implemented method which is configured to train, build, and deploy machine learning models, algorithms, and/or machine learning operations (“MLOps”). The machine learning platform may generate machine learning models, orchestrate and deploy machine learning models, and also conduct health, diagnostic, and/or metrics calculations to reduce problems associated with ongoing use of machine learning in an entity.

As used herein, the term “data flow” may refer to a series of process steps which are interconnected in terms of the order in which these process steps are completed. For example, data flow steps may need to be completed consecutively, or in series, in order for the overall process to be completed correctly. Data flow steps may also be completed simultaneously, or in parallel, in order for the overall process to be completed correctly. The inter-dependency of each data flow step may vary, depending on the process at-hand, and as such in order to maximize efficiency of the overall process, each data flow step should be evaluated to determine which inputs and outputs to each data flow step are required in order to complete to data flow step. For example, data flow step A's output may be an input requirement for data flow step B, and as such it may be a requirement that data flow step B occur, at earliest, immediately after data flow step A. However, data flow step C may have inputs which are independent of data flow steps A and B, and as such, data flow step C may occur at any point during the overall data flow. In some embodiments, data flow steps may represent manual processes currently executed by hand such as signing a letter. In other embodiments, data flow steps may be executed on a system without human interaction, such as digitally signing a digital letter.

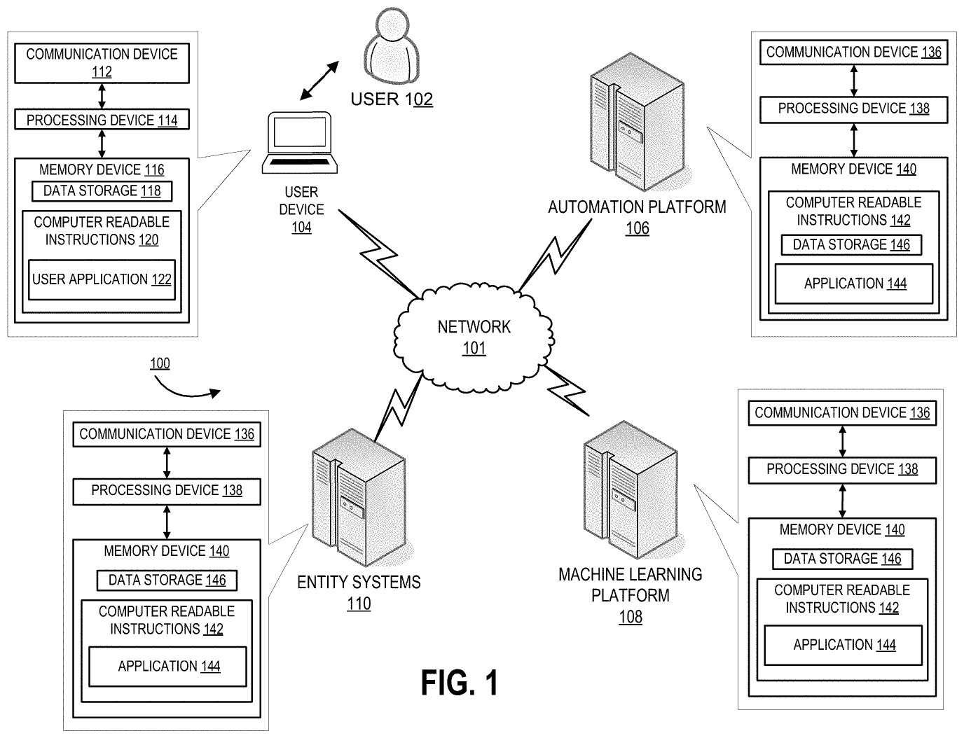

FIG. 1 illustrates a system that includes specialized systems and devices communicably linked across a network to perform a method for optimizing electronic data flow using intelligent machine learning. FIG. 1 provides an environment 100 for the system, in accordance with one embodiment of the present invention.

As illustrated in FIG. 1, the entity systems 110 is operatively coupled, via a network 101 to the user device 104, and to the automation platform 106, and machine learning platform 108. In this way, entity systems 110 can send information to and receive information from the user device 104, automation platform 106, and machine learning platform 108. It shall be noted that in some embodiments of the invention, automation platform 106 and machine learning platform 108 are merely systems along entity systems 110, and as such entity systems 110 may comprise automation platform 106, and machine learning platform 108. FIG. 1 illustrates only one example of the system environment 100, and it will be appreciated that in other embodiments one or more of the systems, devices, or servers may be combined into a single system, device, or server, or be made up of multiple systems, devices, or servers.

The network 101 may be a global area network (GAN), such as the Internet, a wide area network (WAN), a local area network (LAN), or any other type of network or combination of networks. The network 101 may provide for wireline, wireless, or a combination wireline and wireless communication between devices on the network.

In some embodiments, the user 102 is an individual associated with an entity who has the ability and/or authority to access entity systems 110, automation platform 106, machine learning platform 108, or the like. Those skilled in the art will appreciate that at least some example embodiments contemplate multiple such users. In some embodiments, the user 102 has a user device, such as a mobile phone, tabled, computer or the like. FIG. 1 also illustrates a user device 104. The user device 104 may be any communication device such as a smart phone, a telephone, a tablet, a computer, or the like, but is preferably a computing device or terminal. User device 104 can perform computing functions, and the device may be used by the user to access the system and/or network 101 directly or through an application, online portal, internet browser, virtual private network, or other connection channel. The device may be a computer device within a network of connected computer devices that share one or more network storage locations.

The user device 104 generally comprises a communication device 112, a processing device 114, and a memory device 116. The processing device 114 is operatively coupled to the communication device 112 and the memory device 116. The processing device 114 uses the communication device 112 to communicate with the network 101 and other devices on the network 101, such as, but not limited to the entity systems 110, automation platform 106, and machine learning platform 108. As such, the communication device 112 generally comprises a modem, server, or other device for communicating with other devices on the network 101.

As further illustrated in FIG. 1, the user device 104 comprises computer-readable instructions 120 stored in the memory device 116, which in one embodiment includes the computer-readable instructions 120 of a user application 122 and data storage 118. A user device 104 is preferably a personal computing device or terminal, but it may be any communication device, such as a cellular telecommunications device (i.e., a cell phone or mobile phone), personal digital assistant (PDA), a mobile Internet accessing device, or other mobile device including, but not limited to portable digital assistants (PDAs), pagers, mobile televisions, voice assistants, laptop computers, cameras, video recorders, audio/video player, radio, GPS devices, any combination of the aforementioned, or the like. Although only one user device 104 is depicted in FIG. 1, the system environment 100 may comprise a plurality of user devices 104. In some embodiments of the invention described herein, a plurality of user devices 104 is used. In other embodiments, user devices 104 are not necessary for the functionality of the system and may not be integrated into the system in any appreciable manner.

As illustrated in FIG. 1, the entity systems 110 generally comprises a communication device 136, a processing device 138, and a memory device 140. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 138 is operatively coupled to the communication device 136 and the memory device 140. The processing device 138 uses the communication device 136 to communicate with the network 101 and other devices on the network 101, such as, but not limited to the automation platform 106, machine learning platform 108, and the user device 104. As such, the communication device 136 generally comprises a modem, server, or other device for communicating with other devices on the network 101.

As further illustrated in FIG. 1, the entity systems 110 comprises computer-readable instructions 142 stored in the memory device 140, which in one embodiment includes the computer-readable instructions 142 of an application 144. In some embodiments, memory device 140 includes data storage 146 for storing data related to the system environment, but not limited to data created and/or used by the application 144.

Embodiments of the entity systems 110 may include multiple systems, servers, computers or the like maintained by one or many entities. FIG. 1 merely illustrates one of those systems. In one embodiment of the invention, the entity systems 110 is operated by a second entity that is a different or separate entity from the automation platform 106, and machine learning platform 108. In some embodiments, the automation platform 106 and machine learning platform 108 may be part of the entity systems 110. Similarly, in some embodiments, the entity systems 110 is part of the automation platform 106 and machine learning platform 108.

In one non-limiting example of the entity systems 110 the memory device 140 stores an application 144. In one embodiment of the invention, the application 144 may comprise computer executable program code that instructs the processing device 138 to operate the communication device 136 to perform certain communication functions described herein. In one embodiment, the computer-executable program code of an application associated with the network and application 144 may also instruct the processing device 138 to perform certain logic, data processing, and data storage functions of the application.

The processing device 138 is configured to use the communication device 136 to gather data, such as data corresponding to data flows, data flow steps, inputs from a user in terms of interdependency of each data flow step, key output metrics defined by a user, characteristics of data flow steps such as current cycle time, touch time, rework time, wait time, or the like. The processing device 138 stores the data that it receives in its memory device 140.

Automation platform 106 and machine learning platform 108 are each operatively coupled to entity systems 110, user device 104, and/or each other through network 101. Automation platform 106 and machine learning platform 108 have systems with devices the same or similar to devices described for entity systems 110 and/or user device 104 (i.e., communication device, processing device, memory device). Therefore, automation platform 106 and machine learning platform 108 communicate with each other, and/or with user device 104, and/or with entity systems 110 in the same or similar way as previously described with respect to each system.

As such, automation platform 106 and machine learning platform 108 each generally comprise a communication device, at least one processing device, and a memory device. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device is operatively coupled to the communication device and the memory device. The processing device uses the communication device to communicate with the network 101 and other devices on the network 101. As such, the communication device generally comprises a modem, server, wireless transmitters or other devices for communicating with devices on the network 101. The memory device typically comprises a non-transitory computer readable storage medium, comprising computer readable/executable instructions/code, such as the computer-readable instructions, as described below.

As further illustrated in FIG. 1, automation platform 106 and machine learning platform 108 each comprise computer-readable instructions or computer readable program code stored in the memory device. The computer readable instructions, when executed by the processing device 138 are configured to cause the processing device to perform one or more steps described in this disclosure.

It is understood that the servers, systems, and devices described herein illustrate one embodiment of the invention. It is further understood that one or more of the servers, systems, and devices can be combined in other embodiments and still function in the same or similar way as the embodiments described herein.

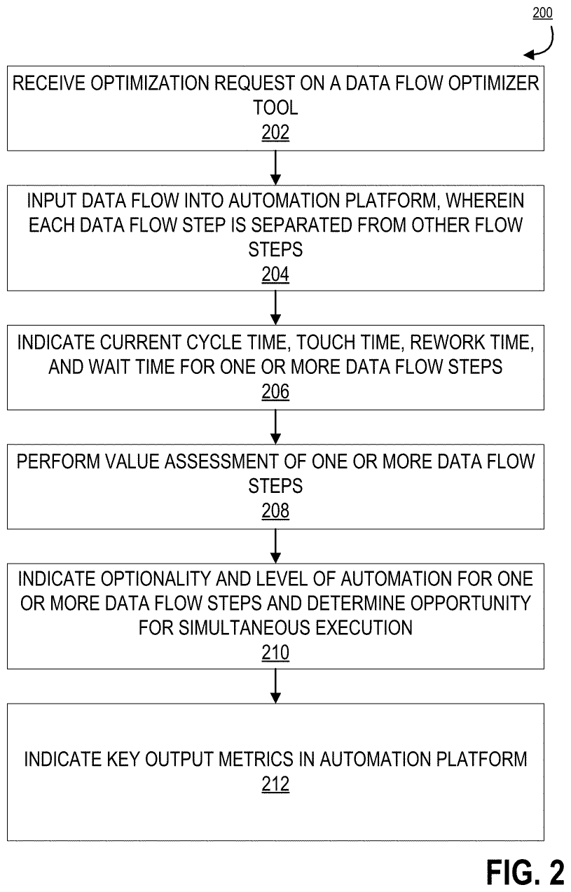

FIG. 2 illustrates a block diagram 200 of a method for providing inputs to a system for optimizing electronic data flow using intelligent machine learning, in accordance with some embodiments of the present invention. As illustrated in block 202, the system first begins by receiving an optimization request from a user on a data flow optimizer tool on the device of a user. The optimization request may be initiated simply by launching the data flow optimizer tool on the graphical user interface of a user device, or there may be preliminary analysis involved to determine which data flow is to be optimized, or an approval process to optimize a data flow. In some embodiments, the optimization request may be facilitated by a user who wishes to optimize a data flow which has previously been optimized. As will be discussed herein, the system is configured to implement machine learning to improve over time and incorporate predictions, preferences, or the like. As such, an optimization request for a data flow which has previously been subjected to optimization may further improve the data flow due to the iterative nature of machine learning.

Examples of data flow which may be subject to the optimization request are numerous. In this way, the system is capable of being applied a wide range of data flows within the processes of an entity. For example, an entity may periodically receive paper letters from customers instructing the entity on how to proceed with a customer's request. Prior to optimization, the entity receives the letter in the mail, an associate opens the letter and reads it, the associate then is tasked with determining the identity of the customer and the matter to which the letter responds. The associate then scans the letter and uploads the scanned image onto a system. Thereafter, another associate is responsible for reviewing the contents of the scanned letter in the system and drafting a response to the customer. A third associate may then be responsible for reviewing the work of the second associate to ensure the quality of the work. Finally, a fourth associate may be responsible for printing the reply letter and mailing it to the customer. A data flow of this type is prone to error and oversight, and as such a user associated with the entity may request that this data flow becomes more automated to eliminate the number of touch points, touch time (amount of time spent or number of instances of touch on a particular data flow step), or the like.

The process continues in block 204 where the automation platform of the system receives, as an input from a user, a data flow. For a data flow which is new to the system (e.g. not optimized previously), the user is primarily responsible for providing to the automation platform a breakdown of each data flow step within the data flow. For example, if a data flow consists of four discrete independent data flow steps, the user provides to the automation platform each of the four data flow steps. In this way, each one of the steps is provided as individualized or separated work package. Continuing with the previous example of mailing a response letter, examples of some of the data flow steps would be i) reading the letter, ii) scanning the letter into the computer system, iii) typing a response letter, and so forth. In addition to the above required input of each individual data flow step, it may also be imperative for the user to provide the automation platform of the data flow optimizer tool with interdependencies between the steps. For example, writing/typing a response letter is only able to occur after the letter has been read, therefore the user indicates in the system that the output of reading the letter is a required input into writing/typing a response letter.

Block 206 represents additional information/factors which may be provided to the automation platform by the user for each of the data flow steps within the current data flow, these factors comprising current cycle time, touch time, rework time, or wait time. Although this information is optional in that the system does not require it for processing an optimized data flow, it may be beneficial to the automation platform to weigh these factors so as to output the most efficient optimized data flow possible at the time of processing. The “current cycle time” is a measurement of time (e.g. seconds, minutes, hours, days, etc.) which elapses while performing one or more data flow steps in the current data flow. “Touch time” indicates a measurement of time (e.g. seconds, minutes, hours, days, etc.) which elapses during which manual work is performed during the data flow. For example, within the data flow step of writing a response to a letter, a total of three minutes may be required to load the document template and save the letter. However, it may require five minutes to formulate the response on the letter. Thus, five minutes would be the touch time indicated to the automation platform. These five minutes could also be defined as value add, non-value add, or required non-value add to support specific data flow optimization needs. “Rework time” is a measurement of time (e.g. seconds, minutes, hours, days, etc.) which elapses while performing a correction as caused by an error in other data flow steps of the data flow. “Wait time” is a measurement of time (e.g. seconds, minutes, hours, days, etc.) which elapses while performing other data flow steps which have outputs required as inputs to the data flow step of which the wait time is being calculated.

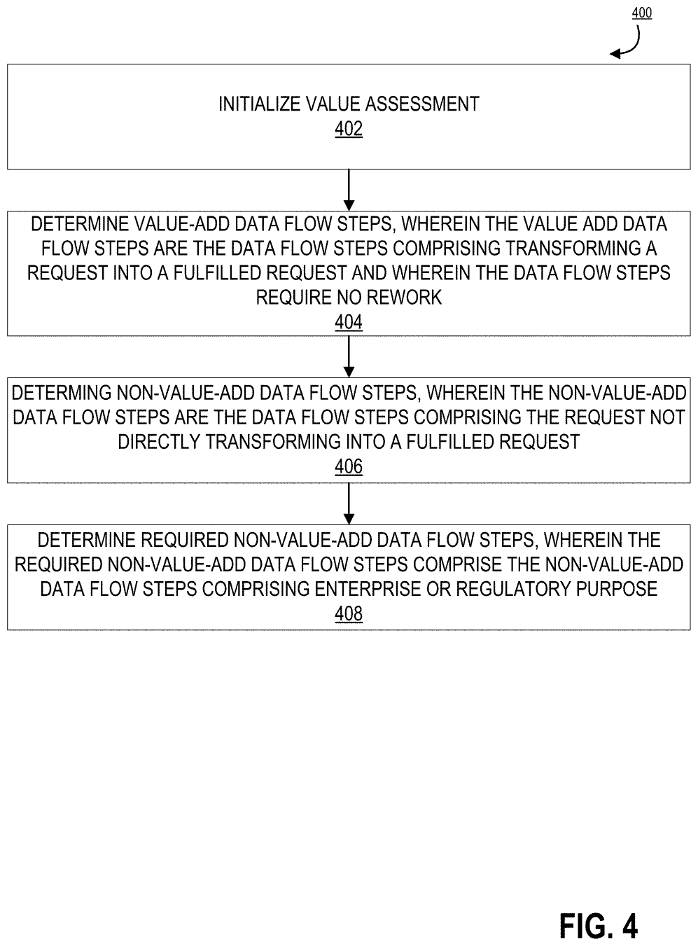

The process continues as indicated in block 208 by performing value assessment of one or more data flow steps. Value assessment will be described at-length in FIG. 4. The primary purpose for assessing the value of each data flow step is to determine which data flow steps are mandatory (e.g. unable to be eliminated entirely), which data flow steps require a quality control/quality assurance check, or the like, by denoting each data flow step as either i) value-add, ii) non-value add, or iii) required non-value add. Each of these value assessments is considered from the perspective of a customer, such that a customer is willing to pay for a data flow step which adds value, but may not be willing to pay for a data flow step which does not add value.

The process continues with block 210, in which the optionality and level of automation are indicated, as well as opportunity for simultaneous execution, are provided to the automation platform. As previously described, some data flow steps may be important and therefore mandatory and not optional. This may be a result of the data flow step being indicated as a “required non-value-add” data flow step, determined in block 208, or it may be determined by a user with intimate knowledge of the data flow and therefore knowledge that a data flow step is absolutely required for completion of the data flow. The level of automation may be indicated to the automation platform, such that a user has knowledge of the ability for a data flow step to be automated, such as scanning and uploading a letter to a computer network or the like. Finally, the opportunity for simultaneous execution, often referred to as “parallel path” execution, may be indicated to the automation platform, such that two or more data flow steps are known to occur or be completed by independent resources. If a data flow step is able to be performed using different resources (or alternatively, the same resource but during the same time period) then it may be beneficial for the automation platform to take this information into consideration in order to minimize the cycle time, effective touch time, and/or cost savings of an optimized data flow.

Although many of the above criteria, factors, specifics, or the like regarding data flow steps may initially be required to be input to the automation platform by a user, this may only be required during the first iteration of processing of a data flow to transform the data flow into an optimized data flow. Thereafter, it is important to understand that using machine learning and an iterative process of data flow optimization, as will be discussed in greater detail hereinafter, these aforementioned criteria, factors, specifics, or the like regarding data flow steps may automatically or autonomously be provided as data to the automation platform by the system, such that no human may be required whatsoever. The system is configured such that data flow may be reevaluated at any time, and the optimized data flow performed by the automation platform may take into consideration improvements in the optimization process as a result of the system gaining artificial intelligence over time, as provided to the automation platform by the machine learning platform.

In block 212, the input to the data flow optimization process concludes by indicating to the automation platform one or more key output metrics. Since the automation platform outputs a plurality of options for an optimized data flow, the automation platform may derive optimized data flows based on prioritizing one or more key output metrics in order to maximize the effectiveness of the outputs of the automation platform. Key output metrics which may be selected for any given data flow include, but are not limited to: cycle time, effective touch time, cost savings, and so forth. Any number of key output metrics may be determined based on the application and/or use of the data flow, such that the key output metric quantifies the effectiveness of the automation. Each key output metric is calculated as an estimate by the automation platform, and the estimates are provided to a user to aid in selection of which option of optimized data flow should be implemented. For example, the automation platform may estimate that in Output 1 (the first of one or more optimized data flow outputs from the automation platform), that cost savings is 10%, cycle time is reduced 10%, and effective touch time is reduced 10%. In contrast, Output 2 may indicate that a cost savings of 20% is achieved, but cycle time and effective touch time remain unchanged. The differences in these key output metrics between Output 1 and Output 2 may be a result of order of operations of the data flow, amount of checks or quality control involved for any particular data flow step, or the like, regardless of the fact that both Output 1 and Output 2 achieve the result of carrying out and completing the overall data flow. As such, block 212 may represent an input to the automation platform of a prioritization of the available key output metrics for any given data flow, such that the automation platform may focus on improvement of the optimized data flow to maximize or minimize any one or more key output metrics. The prioritized key output metrics indicate to the automation platform the amount of weight to be given to any of the key output metrics during the simulation of optimized data flows.

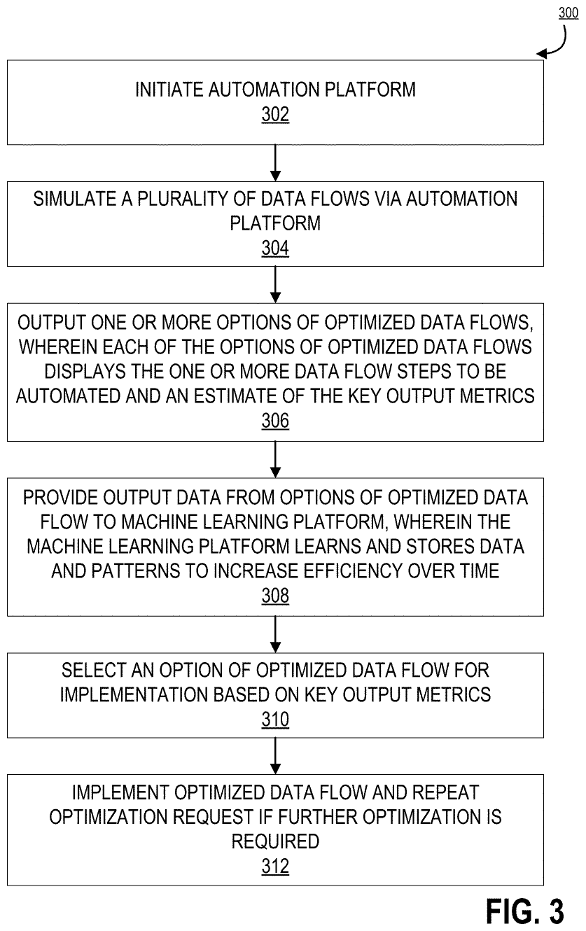

FIG. 3 illustrates a block diagram 300 of generating outputs from a system and method for optimizing electronic data flow using intelligent machine learning, in accordance with some embodiments of the present invention. The process begins in block 302 where the automation platform is initiated, such as to ultimately provide one or more outputs of optimized data flows to present to a user. The initiation of the automation platform may occur automatically in some embodiments where a data flow is being optimized wherein the data flow has already been optimized before and as such there is no user input required to initiate the automation platform. In other embodiments, a data flow may be unique or unfamiliar to the system, and thus the user may be required to initiate the automation platform via a graphical user interface of a user device.

As illustrated in block 304, the process continues by simulating a plurality of data flows using the automation platform. The automation platform may be programmed to move or change parameters of individual data flow steps in a variety of ways (ie: location, order, extent of automation, or the like), calculating key output metrics each time a parameter has been changed. The automation platform may use regression analysis and/or simulated time studies to alter one or more parameter in order to converge at a maximized, minimized, or targeted key output metric as indicated by the input to the automation platform. Furthermore, the automation platform may be capable of receiving input such as minimum key output metrics or maximum key output metrics such that no solutions are calculated for parameter variations which would result in solutions (or optimized data flow outputs, in this case) which output key output metrics which are below or above these minimums and maximums, respectively.

Continuing in block 306, the system outputs one or more options of optimized data flows to a user, wherein each of the options of optimized data flows displays the one or more data flow steps to be automated and an estimate of the key output metrics. Once the automation platform has completed determining which optimized data flows would be most desirable pursuant to the key output metrics provided to the automation platform, the automation platform displays one or more of these options of optimized data flow to the user on a graphical user interface. The options of optimized data flow may be presented alongside a list of the data flow steps which are to be automated (or further automated) in the optimized data flow output. For example, one of the options of optimized data flow outputs may show several data flow steps that are to be automated, whereas a different option of optimized data flow output may only show a single data flow step to be automated. Furthermore, each option of optimized data flow output presented may be accompanied by an estimate of one or more key output metrics, including, but not limited to: improvement in cycle time, cost savings, or the like. Any number of key output metrics may be determined based on the application and/or use of the data flow, such that the key output metric quantifies the effectiveness of the automation. In this way, a user may be able to visually see and compare/contrast the various options of optimized data flow to one another in order to select the appropriate optimized data flow to implement. In some embodiments, the automation platform may recognize one of the options of optimized data flow outputs to be significantly more beneficial than the others, and as such it may highlight this optimized data flow for clarity to the user. In other embodiments, only one optimized data flow output may be possible, and as such the user is not presented with multiple options. In yet additional embodiments, the machine learning platform may provide enough artificial intelligence to the automation platform such that user input is not required for selection of the appropriate options of optimized data flow. In these embodiments, the system may have learned which optimized data flow output selection is most important to a user based on the key output metrics available, as previously described.

In block 308, the process continues by providing output data from the options of optimized data flow to the machine learning platform, wherein the machine learning platform learns and stores data and patterns to increase efficiency over time. The machine learning platform may be a standalone computer executed code which is implemented before, during, and/or after the automation platform has performed optimization of the data flow with the data flow steps. While the automation platform is capable of optimization on its own, efficiency and accuracy of the outputs from the automation platform may be improved when integrated with the machine learning platform. The machine learning platform is configured to learn, using artificial intelligence, the patterns of data flow data input into the system in order to efficiently optimize future data flow data inputs. For example, the system may have previously determined that data flow step A is more efficient when completed before data flow step B. With the machine learning platform, the system is able to recognize the next set of data flow data which has data flow steps A and B and configure the order of operations with respect to data flow steps A and B to optimize the data flow without recalculating all possible configurations of data flow step A relative to data flow step B. In doing so, calculation time of options of optimized data flow per block 306 may be reduced. Furthermore, the machine learning platform may learn user preferences for options for optimized data flow, such that the options for optimized data flow as presented in block 306 are tailored towards a user or an entity's preferences for implementation. For example, the machine learning platform may learn that data flow step B is never chosen to be automated by a user, and thus the system may not present to the user the optimized data flow option which requires data flow step B to be automated. The machine learning platform may also predict which option for optimized data flow is most likely to be chosen, and either automatically choose the predicted option for optimized data flow, or in some embodiments may highlight or direct a user's attention towards the predicted option for optimized data flow by highlighting the predicted option, labeling the predicted option, or the like. It shall also be noted that the machine learning platform stores data such as the previous options for optimized data flow, user inputs, user preferences, prediction algorithms, or the like. The machine learning platform as represented by block 306 is also configured to provide outputs of tutorials to users associated with the entity, such that a new user associated with the entity who is inexperienced may be provided with guidance on data flow design for optimization. The tutorials may provide example optimized data flows to a user and instructions on data flow layout, order of operations, or they may also provide an indication of data flow steps capable of being performed simultaneously, or the like. In this way, the automation platform may be provided with data flow in a near-optimal optimization state, such that true optimization by the automation platform requires fewer resources from the automation platform, since the data flow as input will more-closely resemble the optimized output via the automation platform.

The process continues in block 310, wherein an option of optimized data flow is selected for implementation based on key output metrics. As previously described, the automation platform, in conjunction with the machine learning platform assisting with computations and predictions, outputs one or more options for optimized data flow. Alongside each of these options of optimized data flow is an indication of i) the specific data flow steps which are to be automated, and/or ii) the predicted level of improvement in one or more key output metrics, typically shown as a percentage of improvement or other quantitative metric. As such, a user may have a decision as to which option to select for implementation within the entity. Once the option of optimized data flow is selected, the optimized data flow is implemented across the entity. In some embodiments, there may not need to be any selection performed by a user, and instead the machine learning platform may select the appropriate option for optimized data flow based on the artificial intelligence collected. In yet additional embodiments, only one option for optimized data flow may be calculated due to a previous optimization. As such, the system may not provide options for optimized data flow and may instead proceed with implementation.

In block 312 the process is completed by implementing the optimized data flow. Although in some instances the entity may need to reconfigure systems, processes, or the like in order to implement the optimized data flow, in many embodiments the system in configured to implement the process using the entity systems integrated with the automation platform and machine learning platform, such that minimum or no user input is required. Also illustrated in block 302 in some embodiments is a repetition of the optimization request is further optimization of the data flow is required or desired. In some data flows, one or more data flow steps may become obsolete over time, and as such the entity benefits from one or more additional optimizations of the data flow at a later time than originally optimized. A user may request this further optimization if the user recognizes the need, or in some embodiments the machine learning and/or automation platform may recognize the obsolescence of a data flow step and further optimize the data flow. The system may also be configured in some embodiments to repeat optimization for one or more data flows on a regular interval, such as daily, weekly, monthly, yearly, or the like. The advantage to doing so is that the machine learning platform will have gained functionality and improved its capabilities for optimization with every cycle of optimization. As such, incremental improvements may be made to existing optimized data flows. In some embodiments, a user may be prompted to approve the repeated optimization either before the optimization or after the optimization. In other embodiments, the user may not be prompted, and as such the data flows may be further optimized without user oversight.

FIG. 4 illustrates a block diagram 400 of a system and method for performing a value assessment of a data flow step, in accordance with some embodiments of the invention. The process begins in block 402, where a value assessment is initialized. As previously described in FIG. 2, block 208, a value assessment is conducted and initialized by the automation platform, or in some embodiments by a user, in order to assess the value of each data flow step from a customer's perspective to determine which data flow steps are mandatory (e.g. unable to be eliminated entirely by the automation platform), which data flow steps require a quality control/quality assurance check, or the like, by denoting each data flow step as either i) value-add, ii) non-value add, or iii) required non-value add.

In block 404, the value-add data flow steps are determined, wherein the value-add data flow steps are data flow steps comprising transforming a request into a fulfilled request and wherein the data flow steps require no rework. For a data flow step to be classified as value-add, it must be performed correctly on the first attempt and directly transform a request into a filled request, meaning that there are no intermediate data flow steps involved and the work product of a data flow step is quantifiable at the end of the data flow step. Non-limiting examples of value-add data flow steps include reviewing documents in the system to understand customer needs, extracting information from a system to satisfy an inquiry, printing summary letters with requested information, mailing an approved package to customer, or the like. Data flow steps which a user or automation platform has indicated to be value-add are indicated as such (if known at the time of data flow optimization).

In block 406, the non-value-add data flow steps are determined, wherein the non-value-add data flow steps are data flow steps comprising the request not directly transforming the request into a fulfilled request. For a data flow step to be classified as non-value-add, there may be intermediate data flow steps involved and the work product of the data flow step is not quantifiable at the end of the data flow step. Non-limiting examples of non-value-add data flow steps include assigning a case to a user in the system, sending a case to a quality review team for assessment, emailing a user with required correction notes, approving an inquiry fulfillment in the system, reviewing a case to confirm information is complete and accurate, or the like. Data flow steps which a user or automation platform has indicated to be non-value-add are indicated as such (if known at the time of data flow optimization).

In block 408, the required non-value-add data flow steps are determined, wherein the required non-value-add data flow steps are non-value-add data flow steps comprising an enterprise or regulatory purpose, and as such cannot be foregone and may be subject to additional review, check, or quality control and/or assurance prior to completion of a data flow step or in a subsequent data flow step dedicated to such purposes. A non-limiting example of a required non-value-add data flow step include imaging a paper document or the like. The imaging of a paper document may be fulfilling a regulatory or enterprise purpose and does not add value to the customer, thus it is required. Data flow steps which a user or automation platform has indicated to be required non-value-add are indicated as such (if known at the time of data flow optimization).

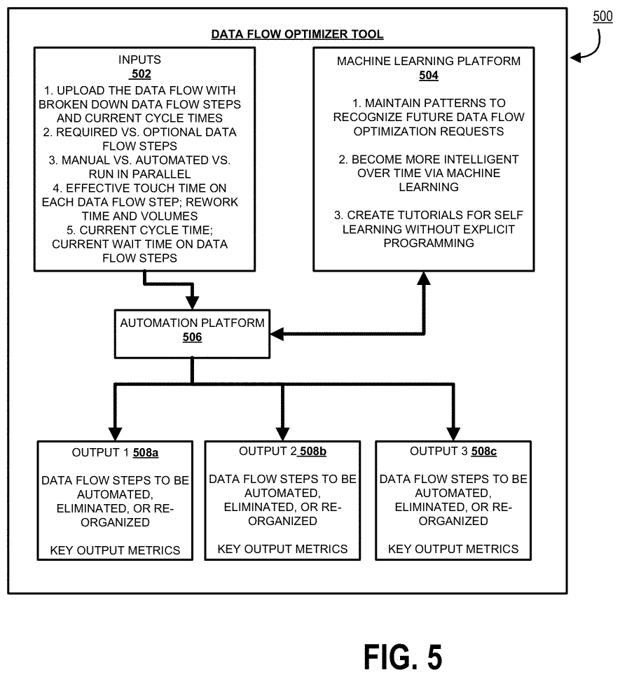

The data flow optimizer tool as previously described, will now be shown graphically in FIG. 5 as a block diagram 500. Block 502 represents the inputs to the data flow optimizer tool. The data flow is uploaded with individualized or separated data flow steps along with current cycle times, required vs. optional data flow steps, manual vs. automated vs. run in parallel, effective touch time for each data flow step, rework time, and volumes. Additionally, current cycle times and current wait times for each data flow step is provided, if available. The inputs in block 502 are provided to the automation platform represented by block 506, where, as previously described, optimized data flows are calculated and simulated based on the inputs. At any point, data may be provided to the machine learning platform represented by block 504. The machine learning platform maintains patters to recognize future data flow optimization requests, becomes more intelligent over time via machine learning and/or artificial intelligence, and creates tutorials without explicitly being programmed to do so. The automation platform in block 506 provides one or more outputs, represented graphically as blocks 508a, 508b, and 508c. Each of the outputs may comprise a list of the data flow steps to be automated, eliminated, and/or reorganized, as well as key output metrics and the net change to said key output metrics as a result of the automation (e.g. process flow change). As used herein, the resulting “automation” of a data flow step does not necessarily construe that the entire data flow step is performed autonomously by a computing device or a machine. As such, in some embodiments, a data flow step subjected to automation may still comprise one or more processes to be completed manually. Data collected as a result of selection of an output may also be provided to the machine learning platform 504 to further improve the machine learning functionality over time. As previously noted, the data flow optimizer tool may be used once for a data flow, or it may be used multiple times for the same data flow at any given interval to continuously improve the efficiency of the data flow.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to data flowchart illustrations and/or block diagrams of systems, methods, and/or computer program products. It will be understood that each block included in the data flowchart illustrations and/or block diagrams, and combinations of blocks included in the data flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the data flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the data flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the data flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for optimizing electronic data flow using intelligent machine learning, the system comprising:
a memory device with computer-readable program code stored thereon;
a communication device;
a processing device operatively coupled to the memory device and the communication device, wherein the processing device is configured to execute the computer-readable program code to:
receive an optimization request, wherein the optimization request is input to a data flow optimizer tool;
input a data flow into an automation platform of the data flow optimizer tool, wherein the data flow comprises one or more data flow steps, and wherein inputting the data flow into the automation platform comprises separating each data flow step from the other data flow steps;
indicate for the one or more data flow steps the current cycle time, touch time, rework time, or wait time;
perform a value assessment of the one or more data flow steps;
indicate for the one or more data flow steps the optionality and level of automation, and determine the opportunity for simultaneous execution; and
indicate one or more key output metrics to the automation platform.

2. The system of claim 1, wherein the processing device is further configured to execute the computer-readable program code to:
initiate the automation platform;
simulate a plurality of data flows via the automation platform;
output one or more options of optimized data flows, wherein each of the one or more options of optimized data flows comprises displaying the one or more data flow steps to be at least one of: automated, eliminated, or reorganized;
displaying an estimate of the one or more key output metrics;
provide output data from the options of optimized data flow to a machine learning platform, wherein the machine learning platform learns and stores data and patterns to increase efficiency of the data flow optimizer tool over time; and
select an option of optimized data flow for implementation, wherein the selection is determined from estimates of the one or more key output metrics.

3. The system of claim 1, wherein performing value assessment of the one or more data flow steps comprises:
determining value-add data flow steps, wherein the value-add data flow steps are the data flow steps comprising transforming a request into a fulfilled request and wherein the data flow step requires no rework;
determining non-value-add data flow steps, wherein the non-value-add data flow steps are the data flow steps comprising the request not directly transforming into a fulfilled request; and
determining required non-value-add data flow steps, wherein the required non-value-add data flow steps comprise the non-value-add data flow steps comprising enterprise or regulatory purpose.

4. The system of claim 1, wherein the optimization request is provided to the data flow optimizer tool by a user on a graphical user interface of a device of the user.

5. The system of claim 1, wherein the optimization request is autonomously provided to the data flow optimizer tool by the processing device, the processing device providing the optimization request for a previously optimized data flow.

6. The system of claim 2, wherein the machine learning platform is further configured to output a tutorial for optimized data flow design, the tutorial indicating to a user instructions for data flow layout.

7. The system of claim 1, wherein the one or more key output metrics provided to the automation platform are prioritized, the prioritized key output metrics indicating to the automation platform the weight to be given to the one or more key output metrics during simulation of a plurality of data flows.

8. A computer program product for optimizing electronic data flow using intelligent machine learning, the computer program product comprising at least one non-transitory computer-readable medium having computer-readable program code portions embodied therein, the computer-readable program code portions comprising:
receiving an optimization request, wherein the optimization request is input to a data flow optimizer tool;
inputting a data flow into an automation platform of the data flow optimizer tool, wherein the data flow comprises one or more data flow steps, and wherein inputting the data flow into the automation platform comprises separating each data flow step from the other data flow steps;
indicating for the one or more data flow steps the current cycle time, touch time, rework time, or wait time;
performing a value assessment of the one or more data flow steps;
indicating for the one or more data flow steps the optionality and level of automation, and determine the opportunity for simultaneous execution; and
indicating one or more key output metrics to the automation platform.

9. The computer program product of claim 8, the computer-readable program code portion further comprising:
initiating the automation platform;
simulating a plurality of data flows via the automation platform;
outputting one or more options of optimized data flows, wherein each of the one or more options of optimized data flows comprises displaying the one or more data flow steps to be at least one of: automated, eliminated, or reorganized;
displaying an estimate of the one or more key output metrics;
providing output data from the options of optimized data flow to a machine learning platform, wherein the machine learning platform learns and stores data and patterns to increase efficiency of the data flow optimizer tool over time; and
selecting an option of optimized data flow for implementation, wherein the selection is determined from estimates of the one or more key output metrics.

10. The computer program product of claim 8, wherein performing value assessment of the one or more data flow steps comprises:
determining value-add data flow steps, wherein the value-add data flow steps are the data flow steps comprising transforming a request into a fulfilled request and wherein the data flow step requires no rework;
determining non-value-add data flow steps, wherein the non-value-add data flow steps are the data flow steps comprising the request not directly transforming into a fulfilled request; and
determining required non-value-add data flow steps, wherein the required non-value-add data flow steps comprise the non-value-add data flow steps comprising enterprise or regulatory purpose.

11. The computer program product of claim 8, wherein the optimization request is provided to the data flow optimizer tool by a user on a graphical user interface of a device of the user.

12. The computer program product of claim 8, wherein the optimization request is autonomously provided to the data flow optimizer tool by the processing device, the processing device providing the optimization request for a previously optimized data flow.

13. The computer program product of claim 9, wherein the machine learning platform is further configured to output a tutorial for optimized data flow design, the tutorial indicating to a user instructions for data flow layout.

14. The computer program product of claim 8, wherein the one or more key output metrics provided to the automation platform are prioritized, the prioritized key output metrics indicating to the automation platform the weight to be given to the one or more key output metrics during simulation of a plurality of data flows.

15. A computer-implemented method for optimizing electronic data flow using intelligent machine learning, the method comprising:
providing a computing system comprising a computer processing device and a non-transitory computer readable medium, where the non-transitory computer readable medium comprises configured computer program instruction code, such that when said computer program instruction code is operated by said computer processing device, said computer processing device performs the following operations:
receiving an optimization request, wherein the optimization request is input to a data flow optimizer tool;
inputting a data flow into an automation platform of the data flow optimizer tool, wherein the data flow comprises one or more data flow steps, and wherein inputting the data flow into the automation platform comprises separating each data flow step from the other data flow steps;
indicating for the one or more data flow steps the current cycle time, touch time, rework time, or wait time;
performing a value assessment of the one or more data flow steps;
indicating for the one or more data flow steps the optionality and level of automation, and determine the opportunity for simultaneous execution; and
indicating one or more key output metrics to the automation platform.

16. The computer-implemented method of claim 15, wherein the operations of the computer processing device further comprise:
initiating the automation platform;
simulating a plurality of data flows via the automation platform;
outputting one or more options of optimized data flows, wherein each of the one or more options of optimized data flows comprises displaying the one or more data flow steps to be at least one of: automated, eliminated, or reorganized;
displaying an estimate of the one or more key output metrics;
providing output data from the options of optimized data flow to a machine learning platform, wherein the machine learning platform learns and stores data and patterns to increase efficiency of the data flow optimizer tool over time; and
selecting an option of optimized data flow for implementation, wherein the selection is determined from estimates of the one or more key output metrics.

17. The computer-implemented method of claim 15, wherein performing value assessment of the one or more data flow steps comprises:
determining value-add data flow steps, wherein the value-add data flow steps are the data flow steps comprising transforming a request into a fulfilled request and wherein the data flow step requires no rework;
determining non-value-add data flow steps, wherein the non-value-add data flow steps are the data flow steps comprising the request not directly transforming into a fulfilled request; and
determining required non-value-add data flow steps, wherein the required non-value-add data flow steps comprise the non-value-add data flow steps comprising enterprise or regulatory purpose.

18. The computer-implemented method of claim 15, wherein the optimization request is provided to the data flow optimizer tool by a user on a graphical user interface of a device of the user.

19. The computer-implemented method of claim 15, wherein the optimization request is autonomously provided to the data flow optimizer tool by the processing device, the processing device providing the optimization request for a previously optimized data flow.

20. The computer-implemented method of claim 16, wherein the machine learning platform is further configured to output a tutorial for optimized data flow design, the tutorial indicating to a user instructions for data flow layout.
